(19) United States
(12) Patent Application Publication
(10) Pub. No.: US 2012/0273698 A1
(43) Pub. Date: Nov. 1, 2012

(54) COUNTERFEIT CURRENCY DETECTOR

(76) Inventors: Stephen F. Gudgell, Rochester, MN (US); Eric T. Brandt, Zimmerman, MN (US)

(21) Appl. No.: 13/455,652

(22) Filed: Apr. 25, 2012

Related U.S. Application Data
(60) Provisional application No. 61/479,085, filed on Apr. 26, 2011.

(51) Int. Cl. B01J 19/12

(52) U.S. Cl. 250/492.1

(57) ABSTRACT

A counterfeit currency detection system including a cash register drawer insert having a plurality of currency openings, each of which is separated from an adjacent currency opening by at least one divider, and a light system including a base member, a plurality of detection lights connected to the base, and a power source, wherein the light system is removably attached to the dividers of the cash register drawer insert.

### CROSS REFERENCE TO RELATED APPLICATION

This application claims the benefit under 35 U.S.C. §119(e) of U.S. Provisional Patent Application No. 61/479,085, filed Apr. 26, 2011 and titled “Counterfeit Currency Detector”, which is incorporated herein by reference in its entirety.

### TECHNICAL FIELD

The present invention generally relates to the detection of counterfeit currency, and more particularly relates to the detection of counterfeit bills with a device that is incorporated into a cash register drawer.

### BACKGROUND

Reports from the Secret Service indicate that there was a 69% increase in counterfeit currency from 2003 through 2006, and this figure has continued to rise. In fact, one estimate indicates that approximately $150,000,000 in counterfeit currency was circulated in the United States in 2009. Many reasons have been suggested for this increase in the counterfeiting of paper currency or bills, including certain technology advances provided by scanning, and printing equipment that allows for relatively accurate copies of currency to be made with a minimal investment by the counterfeiter. In addition, the risks and liabilities taken by businesses that wrongly accuse an individual of passing counterfeit currency can sometimes outweigh the potential benefits of the currently available solutions for identifying counterfeit currency. Further, in response to the relative ease of making counterfeit currency, the United States government continues to change and add anti-counterfeiting features to paper bills to make it more difficult to produce accurate currency reproductions, which in turn, can increase the difficulty for retailers to recognize the differences between authentic and counterfeit currency. This can particularly be true in the somewhat transitory retail business, where the training necessary for recognizing counterfeit bills is sometimes not adequate and/or may not be consistently provided to all employees.

FIGS. 1 and 2 provide two different systems or devices that are currently available for counterfeit bill detection. FIG. 1 illustrates an automatic counterfeit detector that is commercially available as the “Cassida 3300 Automatic Counterfeit Detector” from the Cassida Corporation of Tualatin, Oreg. This system uses infrared imaging technology with a microprocessor to scan individual bills and determine whether they are authentic. While relatively effective, these detectors have become unpopular due to the negative perception that can be conveyed to the customer whose bills are being scanned (i.e., the consumer perception that the retailer believes that the customer is knowingly trying to pass counterfeit bills), the fact that they take up a relatively large amount of counter space, and the time that can be required to run each individual bill through the machine.

FIG. 2 illustrates a commercially available handheld light device that uses a special ink that is swiped across the currency, and then an ultraviolet light (UV) in the pen cap is used to reveal the hidden security strip that identifies the correct denomination. If the exposed strip does not match the denomination on the face of the bill, the currency is likely to be counterfeit. The accuracy of the use of these pens varies considerably and is linked to the skill and training of the cashier that is handling the currency. Like the system illustrated in FIG. 1, these pens can also be unpopular due to the negative perception by the customer that the cashier is suspicious of the customer passing a counterfeit bill.

Another commercially available counterfeit detection pen is particularly designed to detect the type of counterfeit bills that are created by bleaching a bill with a low denomination (e.g., a 5-dollar bill) and reprinting a higher denomination onto that bleached paper (e.g., a 50-dollar bill). These pens are swiped across a face of a bill, which will provide a positive reading for an authentic bill and a negative reading for a counterfeit bill. Although such pens can be a deterrent to counterfeiters, they are not 100% accurate, which leads retailers to be hesitant in adopting them for regular use in their business.

In view of the drawbacks of the above exemplary systems and devices that are available for counterfeit currency detection, along with other commercially available systems, there is a need for a system that can provide quick, discrete, and accurate scanning of currency that is received from a consumer. There is also a need for such systems to be easily adaptable to existing equipment, such as cash registers, that are being used by retailers.

### SUMMARY

In one aspect of the invention, a system is provided for detection of counterfeit currency that includes at least one UV light that is designed for placement in a cash register drawer. The system can optionally include a switch, such as a pressure switch, that can be activated and deactivated to turn the UV light on and off. For example, a pressure switch can be activated to turn the light on when the drawer is opened, and then be activated again or deactivated to turn the light off when the drawer is closed. Other alternative manners of turning the UV light on and off can instead be used, but are desirably relatively discrete. The counterfeit currency detection systems of the invention can advantageously provide a cashier with a relatively discrete manner of screening bills that appear suspicious and/or that are above a certain predetermined denomination. The system can further include a bill guide that is positionable relative to the UV light for use as a convenient guide for determining whether or not bills are authentic. The bill guide can optionally be replaceable to accommodate changes and updates to the anti-counterfeiting features and their positions in different currency.

### BRIEF DESCRIPTION OF THE DRAWINGS

The present invention will be further explained with reference to the appended Figures, wherein like structure is referred to by like numerals throughout the several views, and wherein:

FIG. 1 is a perspective view of one exemplary prior art counterfeit bill detection device;

FIG. 2 is a perspective view of another exemplary prior art counterfeit bill detection device;

FIG. 3 is an exemplary schematic front view of a UV LED bulb for use with the cash register drawer inserts of the invention;

FIG. 4 is a perspective view of a typical cash register drawer containing paper currency and coins in a drawer insert;

FIG. 5 is a perspective view of a typical cash register drawer without a drawer insert;

FIG. 6 is an exemplary schematic top view of a cash register drawer configuration of the invention;

FIG. 7 is an exploded perspective view of a cash register drawer system of the invention;

FIG. 8 is a top perspective view of the cash register drawer insert of FIG. 7;

FIG. 9 is a top view of the cash register drawer insert of FIGS. 7 and 8;

FIG. 10 includes a front view and a back view of an exemplary 100-dollar bill, which includes a security thread that is illuminatable by a UV light of the type that is used with the systems of the invention;

FIG. 11 is a top view of five different U.S. currency denominations with their respective security threads illuminated by a UV light of the type that is used with the systems of the invention;

FIG. 12 is a top view of portions of two 100-dollar bills, wherein the upper bill is an exemplary counterfeit bill and the lower bill illustrates watermarks that are consistent with a legitimate bill;

FIG. 13 is a front view of an exemplary counterfeit detection system of the invention, which includes a UV light built into an existing cash register;

FIG. 14 is a front view of an exemplary counterfeit detection system of the invention, which includes a UV light attachment on an existing cash register; and

FIG. 15 is a front view of an exemplary counterfeit detection system of the invention, which includes a UV light positioned for illumination from a display screen of a cash register.

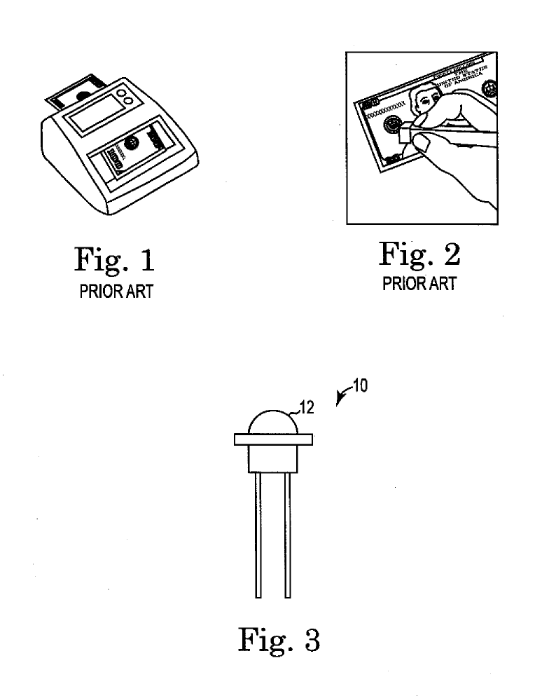

### DETAILED DESCRIPTION

Referring now to the Figures, wherein the components are labeled with like numerals throughout the several Figures, and initially to FIG. 3, one exemplary configuration of a UV bulb 10 of the type that can be used with a counterfeit currency detection system of the invention is illustrated. In an exemplary embodiment, bulb 10 is a LED UV bulb. As shown, the bulb 10 has a spherical top surface 12 from which the light is emitted; however, it is understood that the bulb 10 may instead have another shape, such as rectangular, elliptical, triangular, or the like, where the shape can be chosen or designed so that it can be incorporated into an existing cash register drawer without requiring substantial changes to the drawer. One of more LED bulbs of a particular counterfeit currency detector can have a number of different UV wavelengths, where the UV wavelength of a bulb chosen for a particular counterfeit currency detector is generally in the appropriate light spectrum as the security thread(s) it will illuminate. In one embodiment, multiple LED bulbs are provided in a single currency detection system, wherein each LED bulb is positioned so that it will be directly under the security threads of the bills that will be scanned. The LED bulbs used with the invention may be in the UV light spectrum, for one example, although it is understood that a light that provides more or less UV light can be used in accordance with the invention.

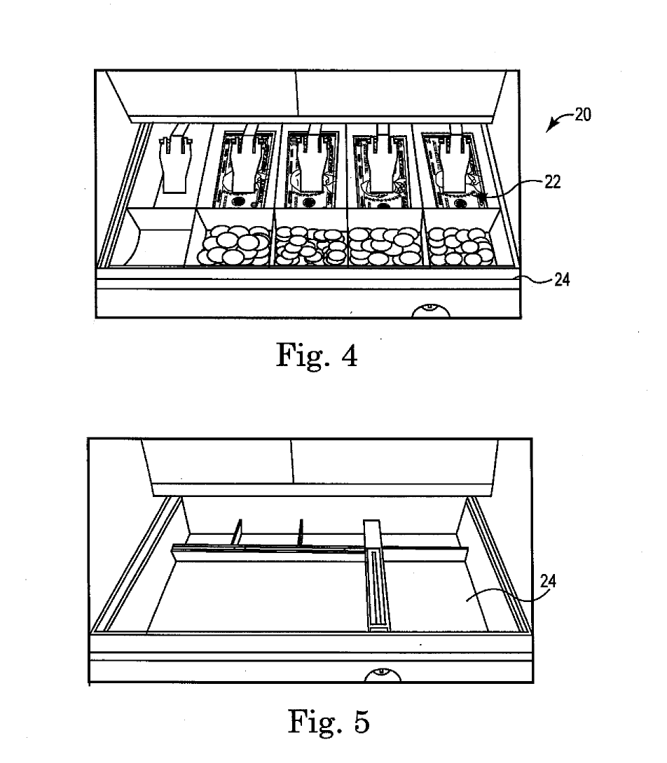

The system illustrated in FIGS. 4 and 5, which includes a drawer insert that is removable from a drawer shell of a cash register, is a typical equipment configuration for many retailers. This arrangement allows for relatively easy removal of the cash from a register by removal of the drawer insert from the drawer shell at the end of a clerk's shift or after the store is closed, for example. In particular, FIG. 4 illustrates a typical cash register drawer 20 that includes a drawer insert 22 positioned inside a drawer shell 24. This drawer 20 is illustrated as containing paper currency and coins in the various paper and coin compartments within the drawer insert 22. FIG. 5 illustrates the drawer shell 24 of FIG. 4 with the drawer insert 22 removed.

As described below, the counterfeit currency detection systems of the invention are easily adaptable for use with current cash register systems, and therefore do not require the retailer to purchase new cash registers or perform extensive modifications to existing equipment. Instead, the retailer only will need to purchase a counterfeit detection system that includes an insert that is sized for positioning within an outer drawer shell of an existing cash register, which can include a drawer with an integrated UV LED light system and/or a UV LED insert that can be incorporated into an existing cash register drawer.

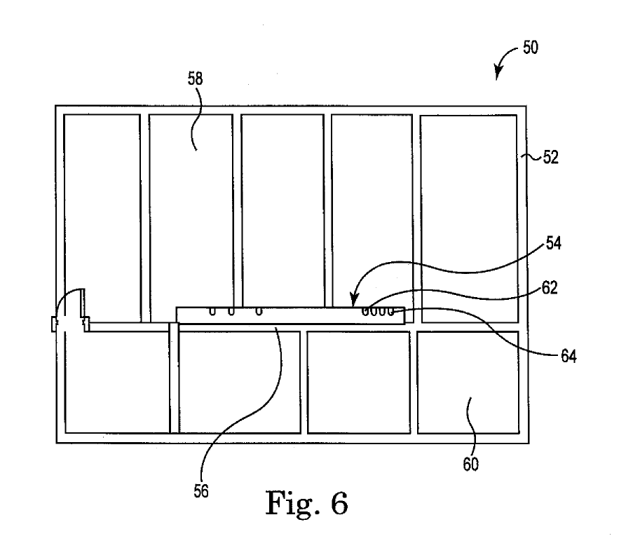

Referring now to FIG. 6, a schematic top view of the interior area of a cash register drawer that includes a counterfeit currency detector system 50 of the invention is illustrated. Detector system 50 generally includes a drawer insert 52, a bill guide 54, and one or more UV lights 56. The drawer insert 52 includes multiple slots 58, 60 of various sizes and shapes and that can be arranged in a number of different ways, although the arrangement shown in FIG. 6 is a fairly typical arrangement for many retailers. That is, the slots 60 for coins can be positioned generally at the front area of the drawer, while the slots 58 for paper currency and checks can be positioned generally at the back of the drawer. As shown, one or more lights 56 or a light assembly are positioned generally in the area that divides the paper currency slots 58 from the coin slots 60, and is located immediately adjacent to the bill guide 54, although it is understood that the UV light(s) 56 and bill guide 54 can be positioned and oriented differently than shown.

Bill guide 54 includes a number of different markings 62, which can be color-coded to match the position and color of a corresponding strip that will be detectable by the UV light. In one embodiment, these color-coded markings 62 are positioned across the width of the bill guide 54 to correspond with the locations that the strips are positioned in an authentic bill. For example, marking 64 of this exemplary bill guide 54 is a narrow strip that is orange in color and includes the text “10” directly adjacent to the marking 64. In this way, the cashier can pass a 10-dollar bill over the UV light 56, with the left side of the bill aligned with a bill alignment guide, for example, and verify that the orange strip of the 10-dollar bill is aligned with the marking 64. With this system, the cashier does not need to memorize the colors and positions of the strips in authentic currency, and the verification process can be virtually unnoticeable by the consumer who gave the bill to the retailer, since the verification process takes place in the cash register drawer itself. Thus, minimal training is necessary for a cashier to be able to accurately determine whether or not certain bills are authentic.

The bill guide 54 can additionally include other markings or instructions, such as an instruction indicating “Place left edge of bill here,” for example. The bill guide 54 can optionally be replaceable or otherwise updatable, which can advantageously allow the retailer to update the system if the government changes or moves certain markings on the currency.

In one embodiment of the invention, power can be provided to the UV light and the corresponding counterfeit currency detector via a battery, which may be replaceable and/or rechargeable, as desired. Alternatively, the detector may be provided with electrical power, which may be provided by attaching the detector to the same source of electricity that is used for the cash register in which it will be installed. In one embodiment, 0.5-volt alkaline batteries provide the necessary power for the detector. In another embodiment, 115 volt AC power is used. In yet another embodiment, a source of DC power is used to provide the necessary power to the detectors of the invention.

The counterfeit currency detectors of the invention can include a switch, such as a pressure switch, which can be activated and deactivated to turn the UV light on and off. For example, a pressure switch can be activated to turn the light on when the drawer is opened, and then be activated again or deactivated to turn the light off when the drawer is closed. A wide variety of other switches or other devices can be used to conserve energy by turning the power on to the currency detector when the detector is in use, and then turning the power off when it is not in use. This type of switching system can be particularly important if the detector is powered by batteries or other external power sources (i.e., not hard-wired).

The walls in the area surrounding and adjacent to the UV light 56 can optionally be provided with a mirrored or reflective surface finish in order to allow the light emitted from the UV light to hit both the top and bottom surfaces of the bills as they are being scanned. In one embodiment, one or more UV bulbs are built into the base of the drawer, which can be provided with a reflective base material (e.g., an aluminum coating) to reflect light upwardly and through a slot or opening in the drawer insert.

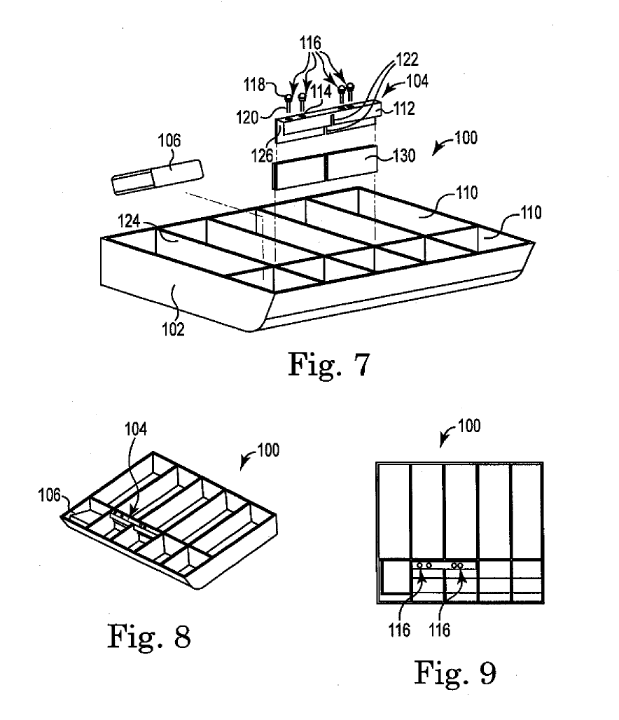

FIG. 7 is an exploded perspective view of an exemplary embodiment of a cash register drawer system 100 of the invention, which generally includes a drawer insert 102, a light system 104, and a power supply 106, and FIGS. 8 and 9 illustrate additional views of the system 100. Drawer insert 102 includes a number of openings 110 for coins, paper bills, checks and the like, where the exact configuration and number of such openings can vary, but generally includes coin slots at the front of the drawer and longer slots for paper at the back of the drawer.

Light system 104 is shown as including a base member 112 with multiple openings 114 in its top surface. Each of the openings 114 is sized to accept an LED light 116, which lights 116 can either be permanently or removably mounted to the base member 112. Each light 116 can be the same or different from the other lights of the light system 104, and in one embodiment, each of the lights 116 is a 350 nm LED light that includes a light-emitting surface 118 and one or more electrical contacts extending in a direction in which a power supply is located. The lights 116 can be positioned in specific locations that correspond to the positions of the detection strips of currency that will be passed over them.

Base member 112 of light system 104 is illustrated as including an exemplary U-shaped channel 126 and slots 122 extending through a length of both sides of channel 126. The slots 122 and the channel 126 can either engage directly with a cash register drawer, or can be attached to a drawer via an intermediate retention plate 130 or other attachment member. Retention plate 130 may be configured as an S-shaped or Z-shaped member, as shown, or the plate 130 can be configured differently. In this illustrated embodiment, however, the light system 104 can be slid into a channel of retention plate 130, and then these components can be slid over the top of dividers 124 that are positioned between openings 110, with the slots 122 also engaging the dividers 124. In this particular embodiment, the dividers 124 with which the slots 122 are engaged are positioned at an approximate 90 degree angle relative to the dividers 124 with which the channel 126 is engaged; however, if the dividers are arranged relative to each other at an angle other than 90 degrees, the components of the light system 104 can be arranged at corresponding angles relative to each other to allow for secure engagement between the light system 104 and the dividers 124. The light system 104 can be held in place simply by this engagement between slots, channels, and dividers and/or the light system 104 can be further secured using additional clips or securing members.

As is also illustrated in FIGS. 7-9, the power supply 106, which is one exemplary manner of providing the desired power to the light system 104, can be placed in one of the openings 110, such as in one of the coin slots located adjacent to the light system 104. Power supply 106 can be a 1.5V power supply, for one example, which can be wired directly or indirectly to the lights 116.

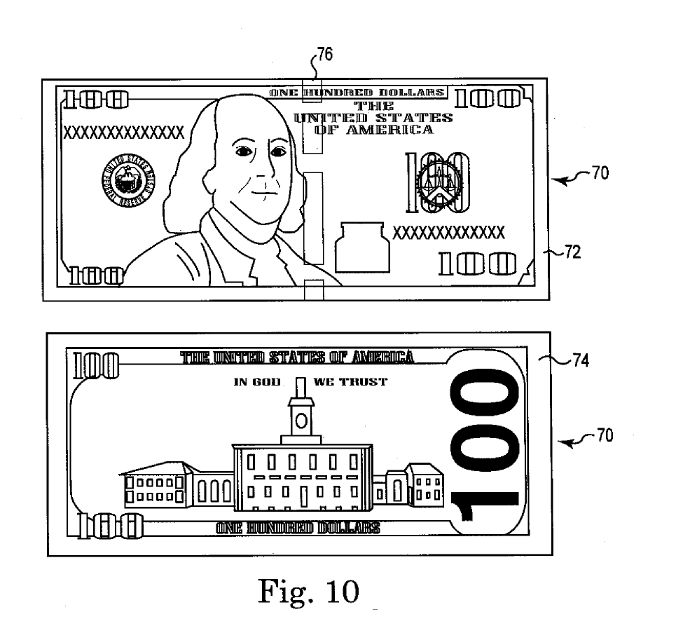

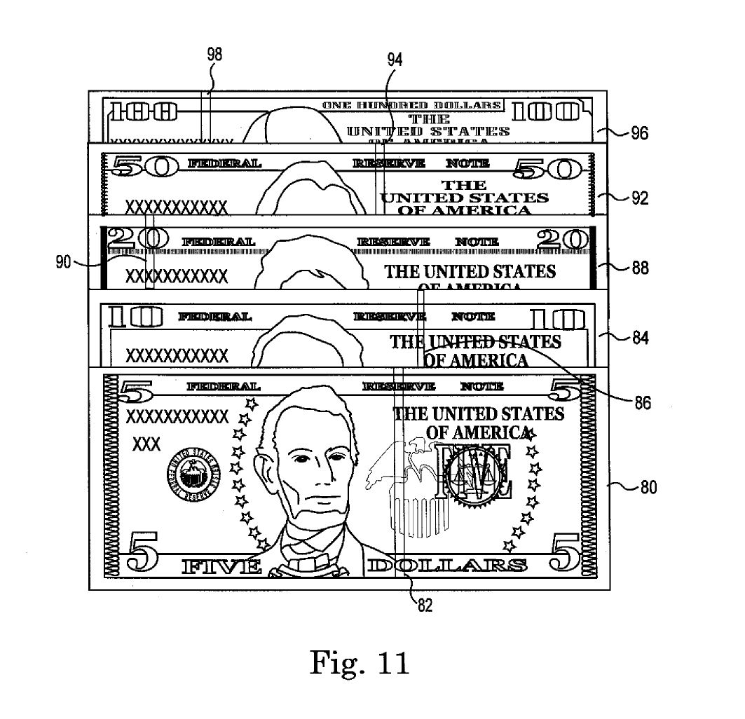

FIG. 10 includes an enlarged portion of a front face 72 of an exemplary illustration of a one hundred dollar bill 70, along with a view of the entire front face 72 and the back face 74 of the bill 70; as such a bill would appear without additional viewing lights. FIG. 10 also includes a security thread 76 that extends generally across the height of the bill and is visible when viewed with a UV light of the type that is used with the systems of the invention. FIG. 11 illustrates exemplary front faces of five different U.S. currency denominations with their respective security threads illuminated by a UV light of the type that is used with the systems of the invention. As can be seen in this figure, the security threads for the different denominations of a five dollar bill 80, a ten dollar bill 84, a twenty dollar bill 88, a fifty dollar bill 92, and a one hundred dollar bill 96 are located in different positions 82, 86, 90, 94, and 98, respectively, relative to the width of each of the bills. In addition to the different positions of these security threads relative to the width of the bills, the security threads may each also have a different color that corresponds particularly with a specific currency amount. The UV LED lights of a light system of the invention (e.g., light system 104 of FIGS. 7-9) are preferably positioned to align with these security threads.

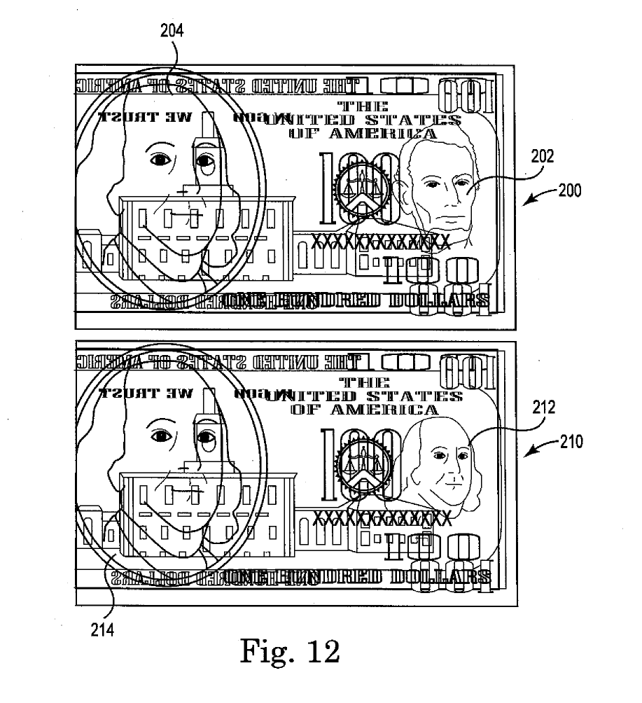

The above discussion is directed mainly to the security features, such as thin security threads, that are provided in U.S. paper currency. However, it is understood that the counterfeit currency detectors of the invention can also be used for detecting counterfeit currency in other countries and/or to detect counterfeit currency that uses light detectable features that are not in the form of a thread. For example, the features that are being detected can take on a particular size and/or shape (e.g., a maple leaf that is detectable only with a certain type of light, such as a UV light), such as one that is not easily duplicated by a counterfeiter. In another example, the features that are being detected can consist more of subtle markings and/or shading across the face of certain currencies. In yet another example, the features that are being detected can be an official government seal that is configured in a certain way and/or positioned in a specific location on the face of the currency. In one particular example, which is illustrated in FIG. 12, a counterfeit one hundred dollar bill 200 is illustrated, which includes a watermark 202 that is visible when the bill is illuminated with a UV light. As shown, the watermark 202 does not match the face 104 that is visible on the front surface of the bill, which can be an additional indicator of a counterfeit bill. As is also illustrated in FIG. 12, a legitimate one hundred dollar bill 210 includes a watermark 212 that does match the face 214 that is visible on the front surface of the bill 210.

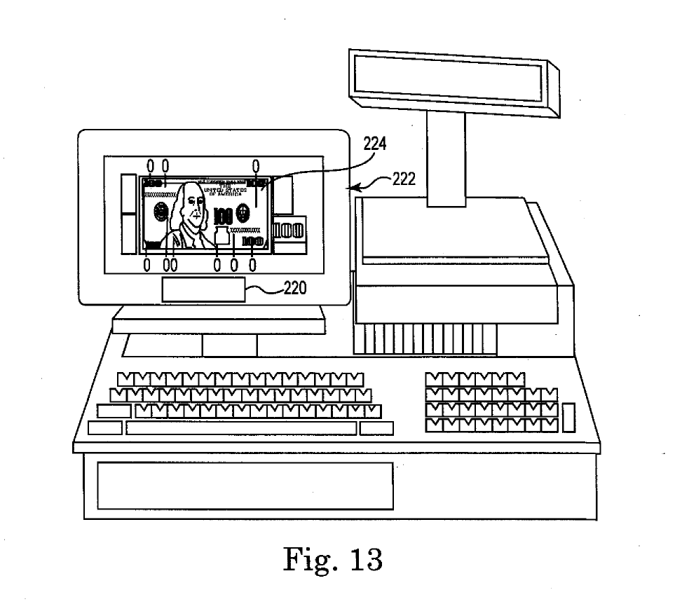

FIG. 13 is a front view of an exemplary counterfeit detection system of the invention, which includes a UV light built into an existing cash register. In particular, the system includes a UV light 220 that is built into or attached to the exterior face of a register screen 222. The area generally indicated by reference number 222 illustrates the security features built into an authentic bill with a counterfeit computer software program. The area generally indicated by reference number 224 illustrates a “to scale” bill as illuminated by a UV light. In operation, a cashier can hold the currency up to the UV light 220 and can optionally press a key or other device that turns on the light 220. This light 220 may stay on for a preset period of time (e.g., 15 seconds) before it turns off automatically, or the cashier may instead press the same or a different key to turn off the light 220. When this system is used with the provided counterfeit computer software, the system would show real size bills to scale with the UV light and additional security features, such as watermark(s) on the front and back on the computer screen, to which the cashier can compare the bill for verification of its authenticity. In addition, the computer software can provide the system with the capability to populate bills having different features, such as those that were produced in different series years (e.g., 1996 series style or 2004 series style). With such a system, the cashier may need to enter the year into the cash register that a particular bill was produced, and then the system will display the counterfeit detection features of that particular year onto the computer screen. For example, a cashier who is handed a 1990 one hundred dollar bill can enter “1990” into the system and various 1990 bills and their corresponding security features would display on the screen, to which the cashier can compare the bill to verify its authenticity.

The computer software discussed above could be purchased with a particular cash register or can be available separately, and would be used to display accurate security features. Upgrades would be available for the software as the security features on certain currency is changed. The system can be configured so that the software is capable of displaying the bill to scale so that a cashier can simply hold up the bill and compare all of the security features to be sure that they all match the display.

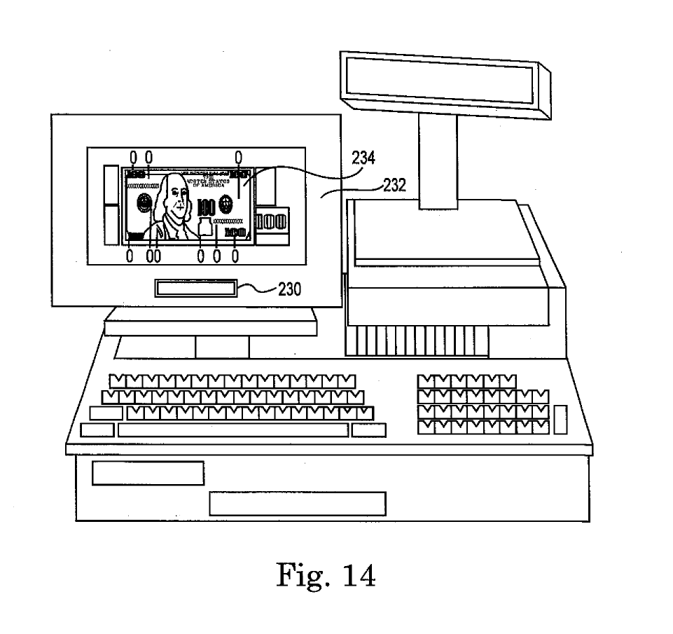

FIG. 14 is a front view of an exemplary counterfeit detection system of the invention, which includes a UV light attachment on an existing cash register. In particular, the system includes a UV light 230 on an attachment member 232. This attachment member 232 can be provided as a separate component that can be attached to existing cash register monitors. The member 232 can be configured so that it does not block the existing viewing screen of the monitor. The area generally indicated by reference number 234 illustrates a “to scale” bill as illuminated by a UV light. In this system, the UV light 230 is part of member 232 that attaches to an existing cash register and would provide a quick retrofit for retailers that wish to continue using their existing cash registers. The UV light of this system can be powered with batteries or a power supply (e.g., a 9V outlet). The system can be activated by pressing a key or switch that turns on the UV light, or can alternatively be activated by a motion sensor or other switching mechanism. In any case, the light may then turn off automatically or may be manually turned off.

As with the system discussed above relative to FIG. 13, the computer software for the system of FIG. 14 can also be purchased with a particular cash register or can be available separately, and would be used to display accurate security features. Upgrades would be available for the software as the security features on certain currency is changed. The system can be configured so that the software is capable of displaying the bill to scale so that a cashier can simply hold up the bill and compare all of the security features to be sure that they all match the display.

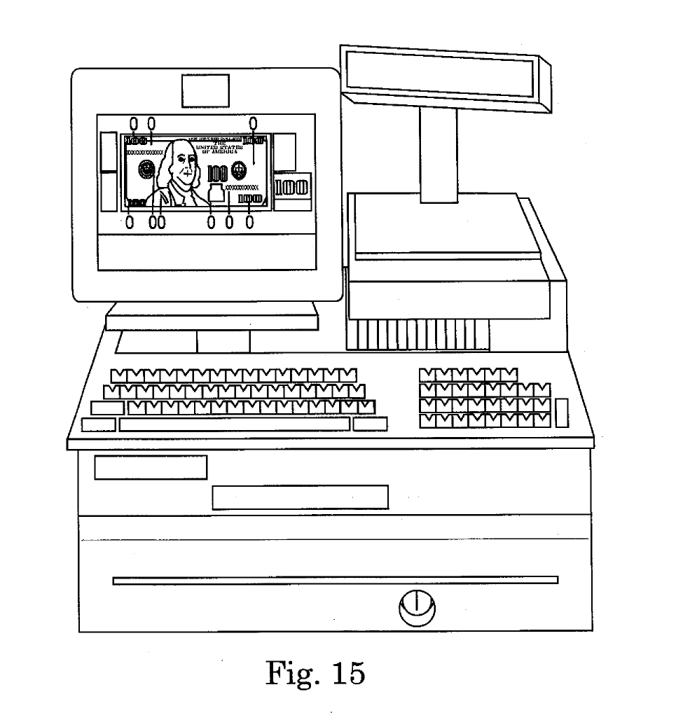

FIG. 15 is a front view of an exemplary counterfeit detection system of the invention, which includes a UV light that projects from the register screen itself, or that is provided as an attachment (e.g., a film member) that is placed on the screen so that the screen converts the light from the register screen to project a desired UV light. The area generally above the UV light projection area illustrates a “to scale” bill as illuminated by the UV light. As with other systems described above, the system of FIG. 15 can be activated by pressing a key or switch that turns on the UV light, or can alternatively activated by a motion sensor. In any case, the light may then turn off automatically or may be manually turned off. The computer software used for this system can have similar features to the software described above relative to FIGS. 13 and 14, for example.

Finally, the counterfeit currency detectors of the invention may be provided with a different type of light than a UV LED light, such as when the currency markings are readable with a different type of light or energy than one that is illuminated by UV light. That is, the invention is not intended to be limited to only UV LED lights or light bulbs, but instead can be used with other pairings of light or energy with a detectable currency feature, wherein such a light or energy source will be configured for installation into a drawer of a cash register or other intake and/or storage location for currency.

The present invention has now been described with reference to several embodiments thereof. The entire disclosure of any patent or patent application identified herein is hereby incorporated by reference. The foregoing detailed description and examples have been given for clarity of understanding only. No unnecessary limitations are to be understood therefrom. It will be apparent to those skilled in the art that many changes can be made in the embodiments described without departing from the scope of the invention. Thus, the scope of the present invention should not be limited to the structures described herein, but only by the structures recited in the claims and the equivalents of those structures.

1. A counterfeit currency detection system comprising:
a cash register drawer insert comprising a plurality of currency openings, each of which is separated from an adjacent currency opening by at least one divider; and
a light system comprising a base member, a plurality of detection lights connected to the base, and a power source operably attached to the plurality of detection lights;
wherein the light system is removably attached to the dividers of the cash register drawer insert.

2. The counterfeit currency detection system of claim 1, wherein at least one of the detection lights comprises a UV bulb.

3. The counterfeit currency detection system of claim 1, wherein at least one of the detection lights comprises an LED UV bulb.

4. The counterfeit currency detection system of claim 1, wherein the base member comprises a plurality of apertures spaced from each other along a detection surface, and wherein each of the plurality of detection lights is positioned within one of the plurality of apertures.

5. The counterfeit currency detection system of claim 1, wherein the base member comprises a channel that is engageable with at least one of the dividers.

6. The counterfeit currency detection system of claim 5, wherein the base member comprises at least one slot that is engageable with at least one of the dividers.

7. The counterfeit currency detection system of claim 1, wherein the plurality of detection lights are spaced from each other along a detection surface of the base member in a pattern that corresponds to a location of predetermined detection features of a plurality of paper currencies.

8. The counterfeit currency detection system of claim 1, in combination with a cash register drawer, wherein the insert is positioned within an opening of the drawer.

9. The counterfeit currency detection system of claim 8, wherein the light system further comprises a switch that is activatable to turn the light on when the drawer is opened, and that is activatable to turn the light off when the drawer is closed.

10. The counterfeit currency detection system of claim 1, further comprising a bill guide comprising at least one visually detectable indicator.

11. The counterfeit currency detection system of claim 10, wherein the bill guide is removable and replaceable.

12. The counterfeit currency detection system of claim of claim 10, wherein the bill guide comprises a plurality of color-coded, visually detectable indicators.

13. The counterfeit currency detection system of claim 1, further comprising a retention plate that is engageable with the base member of the light system, wherein the retention plate comprises at least one slot that is engageable with at least one divider of the drawer insert.

14. A light system for use with a counterfeit currency detection system, the light system comprising;
a base member comprising a channel and a detection surface comprising a plurality of apertures,
a plurality of detection lights, each of which is positioned within one of the plurality of apertures and which emits light outwardly relative to the detection surface; and
a power source operably attached to the plurality of detection lights.

15. The light system of claim 14, wherein at least one of the detection lights comprises a UV bulb.

16. The light system of claim 14, wherein at least one of the detection lights comprises a LED UV bulb.

17. The light system of claim 14, wherein the plurality of detection lights are spaced from each other along the detection surface of the base member in a pattern that corresponds to a location of predetermined detection features of a plurality of paper currencies.

18. The light system of claim 14, in combination with a cash register drawer insert comprising a plurality of currency openings, each of which is separated from an adjacent currency opening by at least one divider, wherein the light system is removably attached to the dividers of the cash register drawer insert

19. The combination of claim 18, wherein the channel of the base member is engageable with at least one divider of the insert.

20. The combination of claim 19, wherein the base member comprises at least one slot that is engageable with at least one of the dividers of the insert.
